(19) United States
(12) Patent Application Publication
(10) Pub. No.: US 2015/0205994 A1
(43) Pub. Date: Jul. 23, 2015

(54) SMART WATCH AND CONTROL METHOD THEREOF

(71) Applicant: Samsung Electronics Co., Ltd., Suwon-si (KR)

(72) Inventors: Sang Hyun YOO, Seoul (KR); Yo Han ROH, Hwaseong-si (KR); Ji Hyun LEE, Hwaseong-si (KR); Ho Dong LEE, Yongin-si (KR); Seok Jin HONG, Hwaseong-si (KR)

(73) Assignee: SAMSUNG ELECTRONICS CO., LTD., Suwon-si (KR)

(21) Appl. No.: 14/566,573

(22) Filed: Dec. 10, 2014

(30) Foreign Application Priority Data
Jan. 22, 2014 (KR) 10-2014-0007882

(51) Int. Cl. G06K 9/00

(52) U.S. Cl. CPC G06K 9/00221

(57) ABSTRACT

A smart watch and a control method thereof are provided. A smart watch includes a display having a position that is changeable; an estimation-based position controller configured to determine an initial target position based on a face position and control the display to be moved to the determined initial target position; a face position determiner configured to, based on a face recognition result, determine whether a face exists in front of the display positioned at the initial target position; and a face recognition-based position controller configured to, in response to determining a face does not exist in front of the display, determine a modified target position to enable the display to be positioned toward a face and control the display to be moved to the modified target position.

### CROSS-REFERENCE TO RELATED APPLICATION(S)

This application claims the benefit under 35 U.S.C. §119(a) of Korean Patent Application No. 10-2014-0007882 filed on Jan. 22, 2014, in the Korean Intellectual Property Office, the entire disclosure of which is incorporated herein by reference for all purposes.

### BACKGROUND

1. Field

The following description relates to a smart watch, a display position control method of a smart watch, and a technique of automatically changing the display position of a smart watch toward a face of a user.

2. Description of Related Art

A smart watch refers to a mobile computing device worn on a wrist. In contrast to a mobile device that is carried by hand, such as a smartphone, a smart watch is designed specifically for being worn on a wrist of the user. Thus, since the display of the smart watch is not normally held in front of the user's eyes, an active action is required for the user to take a look at the display of the smart watch.

For example, smart watch users tend to move their wrists wearing the smart watch toward various directions. Thus, in order to bring a smart watch within the line of sight of a user, the user has to hold the smart watch with the one hand and adjust the position of the display toward a specific area of the wrist. In the event that a user does not have both his/her hands freely, adjusting the display position of the smart watch would be difficult. For example, it is difficult for a user to adjust the position of the smart watch while driving a car or hand-carrying a load.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a smart watch includes a display having a position that is changeable, an estimation-based position controller configured to determine an initial target position based on a face position and control the display to be moved to the determined initial target position, a face position determiner configured to, based on a face recognition result, determine whether a face exists in front of the display positioned at the initial target position, and a face recognition-based position controller configured to, in response to determining a face does not exist in front of the display, determine a modified target position to enable the display to be positioned toward a face and control the display to be moved to the modified target position.

The estimation-based position controller may include a user action detector configured to detect a start action that is set in advance; a display position estimator configured to, in response to the detection of the start action, detect a current situation of a user, and based on the detected situation, estimate a face position and a current position of the display; a target position determiner configured to, based on the estimation result of the display position estimator, determine the initial target position where the display is to be moved; and a display position controller configured to output a control signal that enables the display to be moved from the current position to the initial target position.

The user action detector may be configured to detect the start action through one or more of a gesture recognized by a motion sensor, a voice command recognized by a microphone, and a command input by a key button.

The display position estimator may detect the current situation of the user based on estimation data stored in advance in response to at least one of a current state of the display recognized by a motion sensor, a voice command recognized by a microphone, and a command input by a key button.

The face position determiner may include a face recognizer configured to, in response to the display reaching the initial target position or the modified target position, capture a front where the display is facing and recognize the face during a predetermined time interval, and the face recognition-based position controller may include: a modified target position determiner configured to, in a case where the recognition result of the face recognizer has been determined to be negative, repeatedly perform an operation for re-calculating the initial target position and determining the modified target position, or an operation for re-calculating the modified target position and re-determining the modified target position; and a display position controller configured to output a control signal that enables the display to be moved to the determined or re-determined modified target position every time the modified target position is determined or re-determined by the modified target position determiner.

The target position determiner may be configured to determine or re-determine the modified target position based on a preset standard or a new estimation result of the display position estimator.

The general aspect of the smart watch may further include a restoration position controller configured to restore the display to an original base state based on a user action.

The smart watch may include a predetermined area of a main body that is attached to a predetermined area of a wrist band in a manner that is rotatable. The estimation-based position controller and the face recognition-based position controller may operate a display position moving mechanism that enables the display to be rotated with regard to the wrist band along a predetermined area where the display is attached in a manner that is rotatable.

The smart watch may be attached in a manner that enables a lower side of a main body to translate along a wrist band. The estimation-based position controller and the face recognition-based position controller may operate a display position moving mechanism that enables the display to translate with respect to the wrist band in a direction of winding up a wrist.

The display may be a flexible display. The estimation-based position controller and the face recognition-based position controller may operate a display shape changing mechanism that changes the flexible display between a curved shape and a plane shape.

In another general aspect, a method of controlling a smart watch includes a display of which position is changeable, the method involving: controlling an estimation-based position to determine an initial target position based on a face location and to move the display to the determined initial target position; determining a face position based on a face recognition result in order to determine whether a face exists in front of the display moved to the initial target position; and controlling a face recognition-based position to, in response to determining a face does not exist in front of the display, determine a modified target position to enable the display to be positioned toward the face and control the display to be moved to the modified target position.

The controlling of the estimation-based position may involve detecting a user action to detect a start action that is set in advance, estimating a display position to, in response to the detection of the start action, detect a current situation of a user, and based on the detected situation, estimate a face position and a current position of the display, determining an initial target position to, based on the estimation result from the estimating of the display position, determine the initial target position where the display is to be moved, and controlling a display initial position to output a control signal that enables the display to be moved from the current position to the initial target position.

The detecting of the user action may involve detecting the start action through one or more of a gesture recognized by a motion sensor, a voice command recognized by a microphone, and a command input by a key button.

The estimating of the display position may involve detecting the current situation of the user based on estimation data stored in advance in response to at least one of a current state of the display recognized by a motion sensor, a voice command recognized by a microphone, and a command input by a key button.

The determining of the face position may involve recognizing a face in an image capturing a front of the display during a predetermined time interval in response to the display reaching the initial target position or the modified target position, and the controlling of the face recognition-based position may involve determining a modified target position to, in response to the recognition result from the recognizing of the face of the user being determined to be negative, repeatedly performs an operation for re-calculating the initial target position and determining the modified target position, or an operation for re-calculating the modified target position and re-determining the modified target position; and controlling a display modification position to output a control signal that enables the display to be moved to the determined or re-determined modified target position every time the modified target position is determined or re-determined in the determining of the modified target position.

The determining of the modified target position may involve determining the modified target position based on a preset standard or a new estimation result from the estimating of the display position.

The method may involve controlling a restoration position to restore the display to an original base state based on a user action.

The smart watch may include a predetermined area of a main body that is attached to a predetermined area of a wrist band in a manner that is rotatable, and the controlling of the estimation-based position and the controlling of the face recognition-based position may involve comprise operating a display position moving mechanism that enables the display to be rotated with regard to the wrist band along a predetermined area where the display is attached in a manner that is rotatable.

The smart watch may be attached in a manner that enables a lower side of a main body to translate along a wrist band, and the controlling of the estimation-based position and the controlling of the face recognition-based position may involve operating a display position moving mechanism that enables the display to translate with respect to the wrist band in a direction of winding up a wrist.

The display may be a flexible display. The controlling of the estimation-based position and the controlling of the face recognition-based position may involve operating a display shape changing mechanism that changes the flexible display between a curved shape and a plane shape.

In another general aspect, a smart watch includes a main body configured to be positioned on a wrist, a display configured to be positioned in the main body and having a display surface configured to form a tilt angle with respect to a bottom surface of the main body, a camera configured to capture an image, a face recognizer configured to recognize a face from the image; and a position controller configured to adjust the tilt angle of the display surface based on a location of a face recognized in the image captured by the camera.

The position controller may be configured to change the tilt angle of the display surface in response to the face recognizer determining that a face is not recognized in the image captured by the camera.

The display surface may be configured to form a tilt angle of approximately 20 to 90 degrees with the bottom surface of the main body.

Other features and aspects will be apparent from the following detailed description, the drawings, and the claims.

### BRIEF DESCRIPTION OF THE DRAWINGS

FIG. 1 is a diagram illustrating an example of an apparatus for changing a display position of a smart watch.

FIG. 2 is a diagram illustrating an example of a smart watch that includes an apparatus for changing a display position.

FIG. 3 is a flowchart illustrating an example of a method of controlling a display position of a smart watch.

FIG. 4 is a flowchart illustrating an example of an operation for controlling a position of a display based on estimation according to FIG. 3.

FIG. 5 is a flowchart illustrating an example of an operation for determining a face position and an operation for controlling a position of a display based on face recognition according to FIG. 3.

FIG. 6 is a flowchart illustrating an example of an operation for restoring a display to its original position according to FIG. 3.

FIG. 7 is a diagram illustrating an example of a display of a smart watch in a base state.

FIG. 8 is a diagram illustrating an example of a display of a smart watch according to FIG. 7 in a state where the display is turned on a wrist band in a changed position.

FIG. 9 is a “A-A” sectional view of the example of smart watch illustrated in FIG. 7 for comparing and showing relative positions of displays according to FIGS. 7 and 8.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

An exemplary embodiment of a smart watch and a control method thereof provides a technology for changing a display position of a smart watch. The technology may be applied to a smart watch with a main body that is equipped with a display and attached to a wrist band. The technology includes moving the display between a base state in which the display screen is attached to the wrist band and a changed state in which the display position changed relative to the wrist band and a bottom surface of the main body.

An apparatus for changing a display position of a smart watch may be implemented by a smart watch including computer-readable software, applications, programs, program modules, routines, or instructions capable of performing a task for changing the display position when executed by a processor.

Also, a method for changing a display position of a smart watch may be executed by a smart watch including computer-readable software, applications, programs, program modules, routines, or instructions capable of performing a task for changing the display position when executed by a processor.

The technology for changing a display position of a smart watch may involve moving a position of a display with respect to a wrist band disposed on a user's wrist; for example, to perform an estimation-based position control to temporarily or roughly move the display position, and to perform a face recognition-based position control to definitely or precisely move the display position.

For example, it is assumed that a display of a smartphone, a tablet, a television, a laptop, or a desktop computing device generally faces a face of the user. Thus, in order to help the user look at the display conveniently, the face of the user may be first recognized and then a display angle or an angle of the content displayed on the display may be adjusted.

In contrast, the smart watch is a wearable computing device that is worn on a wrist. It is not assumed that the display of the smart watch always faces the user. Thus, it is difficult to apply, to the smart watch, a technology for first recognizing a user's face, and then based on the face recognition result, moving a display screen.

The technology for changing a display position of a smart watch includes technologies for an estimation-based position control, a face position determination, and a face recognition-based position control.

In the estimation-based position control technology, a location of the user's face is first estimated, and an initial target position is determined, wherein the initial target position is an estimated position where that the display will face the user's face, if the display moves to the initial target position. And then, the display may be controlled to be moved to the initial target position temporarily. Thus, the display is moved or transformed from a base state to a changed state.

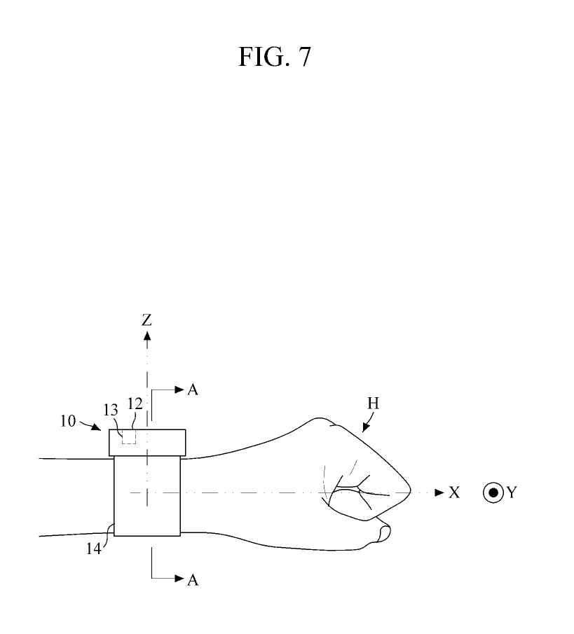

In this example, the ‘base state’ generally indicates a state where a display of a smart watch is attached to a wrist band, as further described below with reference to FIG. 7. In the base state, the display of the smart watch is placed in parallel to a wrist area of a back of the hand as a general wrist watch.

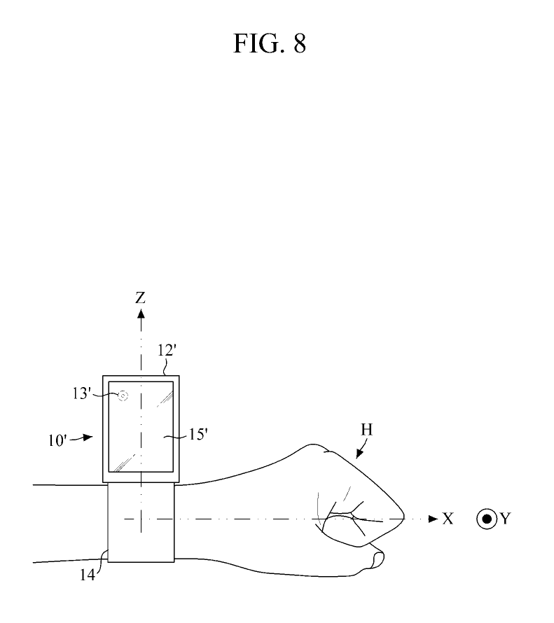

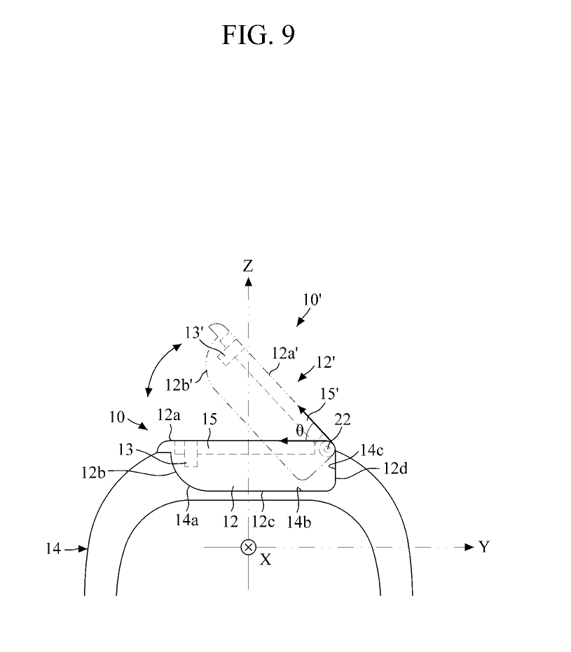

Also, in this example, the ‘changed state’ indicates a state where the display of the smart watch is not in the base state so that its position is changed, as further described below with reference to FIG. 8. There may be a variety of changed states depending on a mechanism for moving the display of the smart watch. The changed state may, for example, indicate a state where the display is rotated with respect to a wrist band, as further described below with reference to FIGS. 8 and 9. Above this, the changed state may indicate a state where the display is translated along the wrist band. Furthermore, if the display is flexible, the changed state may, for example, indicate a state where the display is on the wrist in a flat form, which is changed from a base state where the display is wound on the wrist in a curved-shape.

Since the initial target position is based on the user estimated face position, it is an estimated value. So, it is expected that the display moved to the initial target position will not always be facing the user's face. Thus, the position of the display of the initial target position needs to be adjusted precisely.

The face recognition-based position control entails precisely adjusting the position of the display, which is at the initial target position, through the face recognition using a camera. To this end, determining the face position is performed based on the face recognition.

That is, at the initial target position, a camera may capture one or more images during a predetermined time interval so as to determine whether the user's face exists right in front of the display. Then, a face recognition process of recognizing the user's face with respect to the taken image may be performed. Based on such a face recognition result, it may be determined whether or not the display is directed toward the user's face.

The face recognition-based position control is determining a modified target position based on the face recognition result.

According to the face recognition, if it has been determined that the user's face is located to look at the display conveniently, the display is maintained as it is at the current target position. However, according to the face recognition result, it may be negatively determined as that the user's face is not in the captured image, as that only some of the user's face is in the captured image, or as that while the entire user's face is in the captured image, the display is not in a position for the user to look at it conveniently.

In such cases of the negative determination of the face recognition, a modified target position is estimated, and the face recognition is performed again at the modified target position when the display has been moved, and based on the result of the face recognition, a new modified target position may be re-estimated. Then, the display may be moved again to the re-estimated, new, and modified target position. These processes may be repeatedly performed until the face recognition result becomes positive.

Thus, even if the display of the smart watch does not face the user's face, an apparatus and method for automatically changing the display position of the smart watch to a position where the user can see the display conveniently can be implemented.

The user may, for example, enable the display of the smart watch to be automatically moved so as to bring the display within the line of sight of the user by a gesture, such as flipping over the wrist where the smart watch is worn.

In another example, instead of a gesture, the user may enable the display to be automatically moved by a voice command, such as screaming out “Display!”, so that the display of the smart watch may be brought within the line of sight of the user.

In yet another example, the user may enable the display to be moved by manipulating control buttons, such as pushing one or two or more buttons among virtual or physical key buttons equipped in the smart watch, so that the display of the smart watch may be brought within the line of sight of the user.

According to a technology of changing a display position of a smart watch, the user may automatically restore the display of the changed state to a base state through a simple gesture, a voice command, or a key button input.

For example, the user may restore the display to the base state by a gesture, such as quickly and shortly swinging from side to side of the wrist where the smart watch is worn. This restoring gesture may be different from the gesture of moving the display of the smart watch to the target position.

In another example, the user may restore the display to the base state through a voice command, such as “To the original position!”. This restoring voice command may be different from the voice command for moving the display of the smart watch to the target position.

In yet another example, the user may restore the display to the base state through an input of a specific key button or a combination of key buttons. This restoring key button or buttons may be different from the key button or buttons of moving the display of the smart watch to the target position.

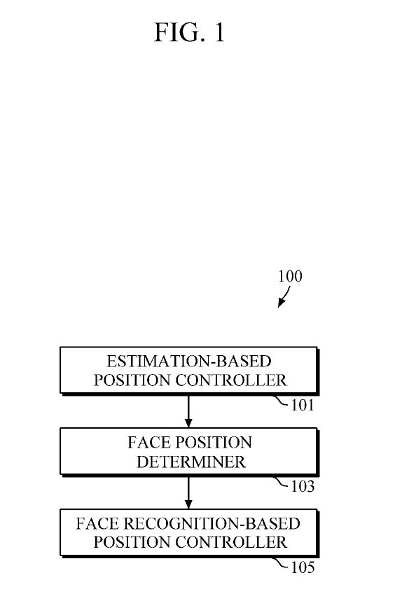

Hereinafter, an apparatus and method for changing a display position of the smart watch is described with reference to FIGS. 1 to 9.

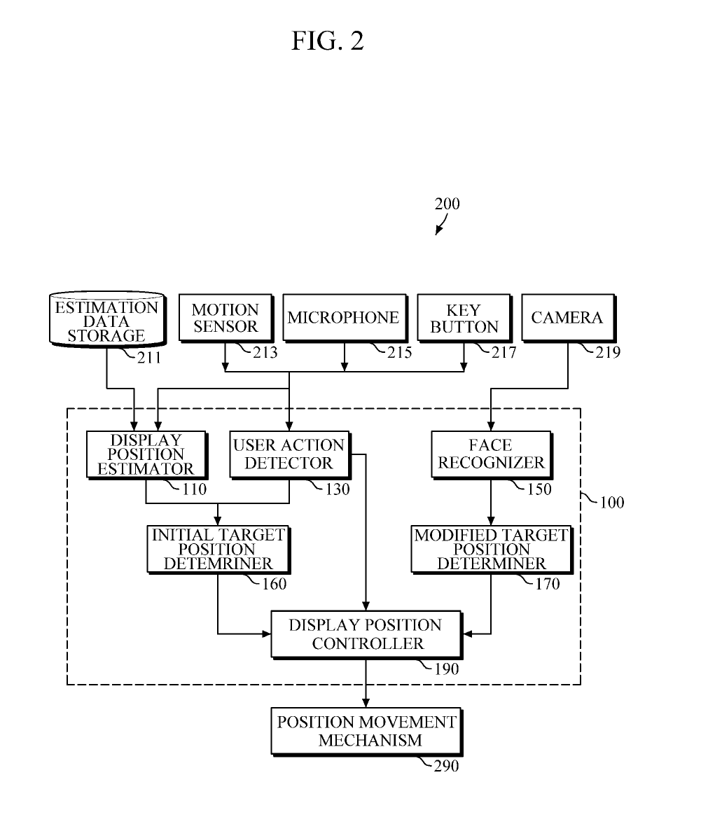

Referring to FIGS. 1 and 2 as illustrated therein, an apparatus for changing a display location of a smart watch is described.

FIG. 1 is a diagram illustrating an apparatus for changing a display pose of a smart watch according to an exemplary embodiment. FIG. 2 is a diagram illustrating an example of a composition of a smart watch that includes an apparatus for changing a display position of a smart watch.

Referring to FIG. 1, an apparatus 100 for changing a display position of a smart watch includes an estimation-based position controller 101, a face position determiner 103, and a face recognition-based position controller 105. Referring to FIG. 2, the apparatus 100 may include components, such as a display position estimator 110, a user action detector 130, a face recognizer 150, an initial target position determiner 160, a modified target position determiner 170, and a display position controller 190.

The estimation-based position controller 101 of FIG. 1 may include the display position estimator 110, the user action detector 130, the initial target position determiner 160, and the display position controller 190 of FIG. 2. The face position determiner 103 of FIG. 1 may include the face recognizer 150 of FIG. 2. In addition, the face recognition-based position controller 105 of FIG. 1 may include the modified target position determiner 170 and the display position controller 190 of FIG. 2.

Here, the display position controller 190 may be included in the estimation-based position controller 101, as well as in the face recognition-based position controller 105.

In the estimation-based position controller 101, the user action detector 130 may be components for detecting a predetermined user action. The user action detector 130 may detect a start action through a user gesture, an auditory input from the user, a voice command, a key button input, and the like. The user gesture may be detected by a motion sensor including one or more sensors, such as a gyro sensor and an acceleration sensor. The motion sensor may be equipped in the smart watch and detect arm or wrist movements of a user wearing the smart watch. The auditory input may be a voice command that is input from the user through the microphone equipped in the smart watch. The key button may be a button for a command input, which is equipped outside the main body of a smart watch. In another way, the key button may be a virtual key button displayed on a touch-sensitive display.

In an estimation-based position controller 101, the display position estimator 110 may be a component for estimating various data related to a display position. If the user action detector 130 detects the user start action, the display position estimator 110 detects a current user situation, and estimate the location of the user's face and the current display position of the smart watch based on the detected situation.

The display position estimator 110 detects the current user situation based on estimation data stored in advance in response to at least one of a current state of a display recognized by the motion sensor, the user voice recognized by the microphone, and the user command input by the key button.

The motion sensor may detect movements of the display and may include sensors, such as a position sensor, such as GPS, an acceleration sensor, or a gyro sensor. For example, considering a case where the user is driving, the motion sensor in the smart watch worn on the user wrist may detect the current user situations, such as a vibration and/or speed of the car. In addition, the detected situation may be used with the estimation data stored in advance to determine the current user situation of “driving”.

In another example, the user may input a situation of “driving” with a voice input. In this case, the display position estimator 110 may recognize the user voice to thereby detect the current situation where the user is driving. In yet another example, the user may push a key button for inputting a command, which is installed in the smart watch, to thereby input a command corresponding to an indication of “driving”.

If the current user situation is detected, the display position estimator 110 may estimate the face position, in a case where the user is driving, with reference to the data stored in advance. For example, the estimation data may be stored in advance, which is “if the user is driving, the user face position exists on a position where the user face turns around 10 to 20 degrees.” If the user's face position is estimated through such estimation data, the relative current position of the display with respect to the user's face position may be estimated.

In an estimation-based position controller 101, the initial target position determiner 160 may determine the initial target position where the display will be moved based on the estimation result by the display position estimator 110.

In an estimation-based position controller 101, if the initial target position is determined by the initial target position determiner 160, this initial target position may be transferred to the display position controller 190. Then, the display position controller 190 may output a control signal that enables the display to move from the current position of the display to the initial target position.

In the face position determiner 103, when the display has reached the initial target position or the modified target position, the face recognizer 150 captures images of a front area where the display is facing during a predetermined time interval, and recognizes the face of the user from the captured images.

For example, the face recognizer 150 may capture the display's front scenery or a temporary object through the camera disposed on the display of the smart watch. The capturing action of the camera may be performed during a predetermined regular time interval, such as approximately for 0.1 second, immediately after the display reaches the initial or modified target position.

Then, through such a determination of whether a face is included in the image captured by the camera, a face recognition operation may be performed. The face recognition operation may be performed by using one of various known face recognition algorithms.

If the face recognition has been determined to be positive, the display may be maintained at the current target position. For example, if it is recognized that the user's face exists within the image captured at the current target position, the result of the face recognition is positive, then the display may be maintained at the current target position. Furthermore, if the current position, based on the recognized face of the user, is determined as enabling the user to see the display conveniently, the face recognition result may be treated to be more positive.

Otherwise, if the face recognition result has been determined to be negative, it may be determined that the display should be moved further beyond the current position. For example, either in a case where the user's face is not recognized within the image captured at the current position, or even though the user's face is recognized, in a case where the position is determined as not enabling the user to see the display conveniently, the result of the face recognition is negative, then it may be determined that the display should be moved further from the current position.

Thus, in the face recognition-based position controller 105, the modified target position determiner 170 re-calculates the initial target position and determines a modified target position when the display is at the initial target position. Further, in a case where the display has already been at a modified target position and the result of the face recognition is negative, the modified target position determiner 170 may repeat re-calculating this modified target position, and determining a new modified target position.

Here, the modified target position determiner 170 may determine or re-determine a modified target position based on a predetermined reference or based on a new estimation result of the display position estimator 110 when determining or re-determining a modified target position. For example, the predetermined reference may include references, such as “a new modified target position is determined as a position rotated by one degree than a previous modified target position.” For another example, the modified target position determiner 170 may estimate a modified target position based on the estimation data stored in advance in the display position estimator 110. For example, the estimation data may include estimations, such as “a new modified target position is determined after being rotated three degrees higher than a previous modified target position in the event that the user's face is only on the upper portion of the image.”

In the face recognition-based position controller 105, the display position controller 190 may output a control signal that enables the display to be moved to the determined or re-determined modified target position every time a modified target position is determined or re-determined by the modified target position determiner 170.

Moreover, referring to FIG. 2, a smart watch 200 may include an estimation data storage 211 storing estimation data in a nontransitory memory, a motion sensor 213, a microphone 215, key buttons 217, a camera 219, and a position movement mechanism 290, in addition to the apparatus 100 for changing a display position of a smart watch illustrated in FIG. 1.

The estimation data storage 211 may be configured to store related data, such as a user situation, an amount of display's movements, and history of data previously applied, and the like.

The motion sensor 213 may include at least one sensor that can detect the smart watch's longitude and latitude, acceleration, degree, or the like.

The microphone 215 may recognize the user's voice, input together with a voice recognition algorithm.

The key button 217 may be either a physical button or a virtual button, such as a virtual keypad displayed on a touch-sensitive display of the smart watch for inputting an instruction.

The camera 219 may capture a front environment or object of the smart watch's display.

The position movement mechanism 290 is a mechanism for physically moving the display with reference to a wrist band. For example, the position movement mechanism 290 may be a mechanical mechanism where the display rotates with reference to a hinge, where the display and the wrist band are coupled with the hinge. In another example, the position movement mechanism 290 may be a mechanical mechanism for translating the display along the wrist band in a direction of winding up around the user wrist. In this case, the display's position is moved from one position to another position on the wrist band in a direction of winding up around the wrist, which consequently helps to gain an effect for a surface of the display to move around the wrist. In yet another example, the position movement mechanism 290 may be a mechanism for changing the shape of a flexible display either from a curved surface to a flat surface, or vice versa.

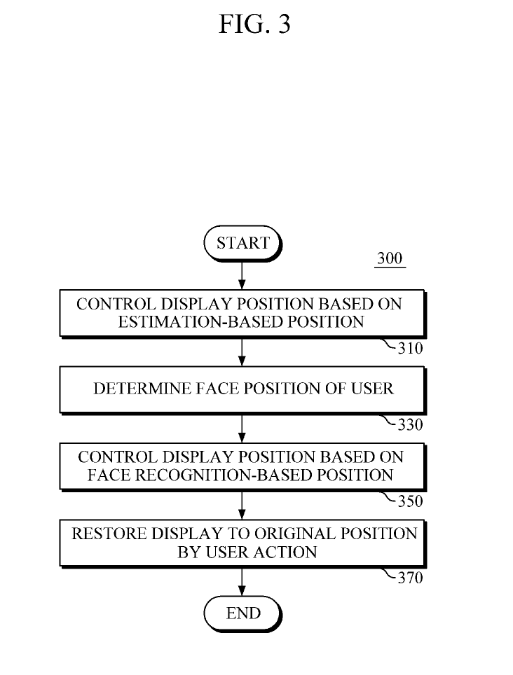

Hereinafter, referring to FIGS. 3 to 6, an example of a method for changing a display position of a smart watch is described.

FIG. 3 is a flowchart illustrating an example of a control method for changing a display position of a smart watch.

Referring to FIG. 3, an embodiment of a method 300 for controlling a display position of the smart watch may include operations of controlling a position of the display based on an estimation in 310, of determining a user's face position in 330, of controlling the position of the display based on a face recognition in 350, and of restoring the position of display based on a user action in 370.

The method 300 may be implemented by a smart watch in which computer-readable instructions, programs, modules, applications, or software are installed to implement a task that changes the display position of the smart watch when implemented by a processor of the smart watch.

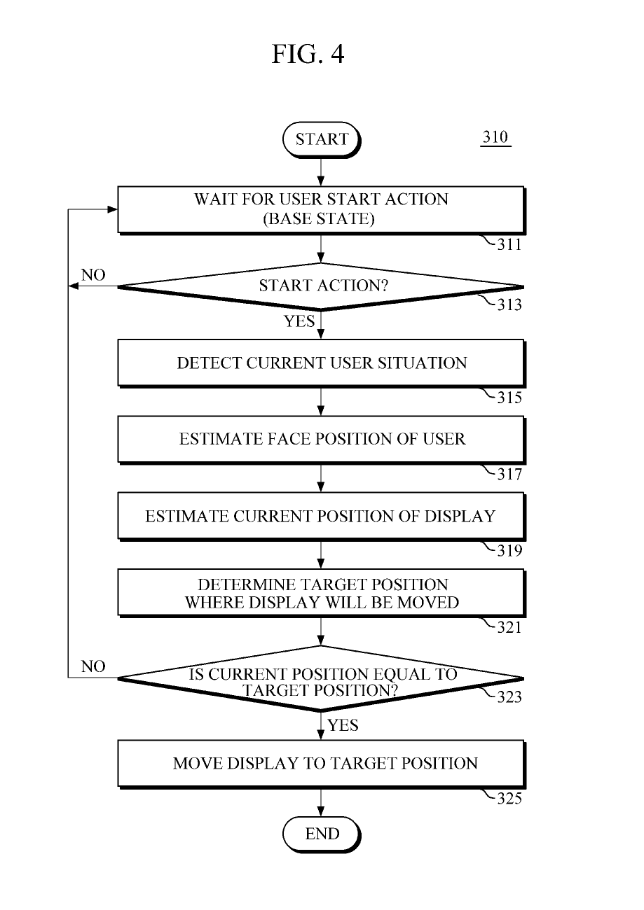

In 310, the display is moved to an initial target position determined based on the estimated face position of the user. The operations of 310 are further described below with reference to FIG. 4.

In 330, it is determined whether the user's face is positioned in front of the display of the smart watch at the initial target position after the display has been moved to the initial target position. In this operation, whether the user's face exists in front of the display may be recognized by using a camera of the smart watch.

In 350, a modified target position is determined based on the user's face recognition result of operation 330, and the display is moved to the determined modified target position.

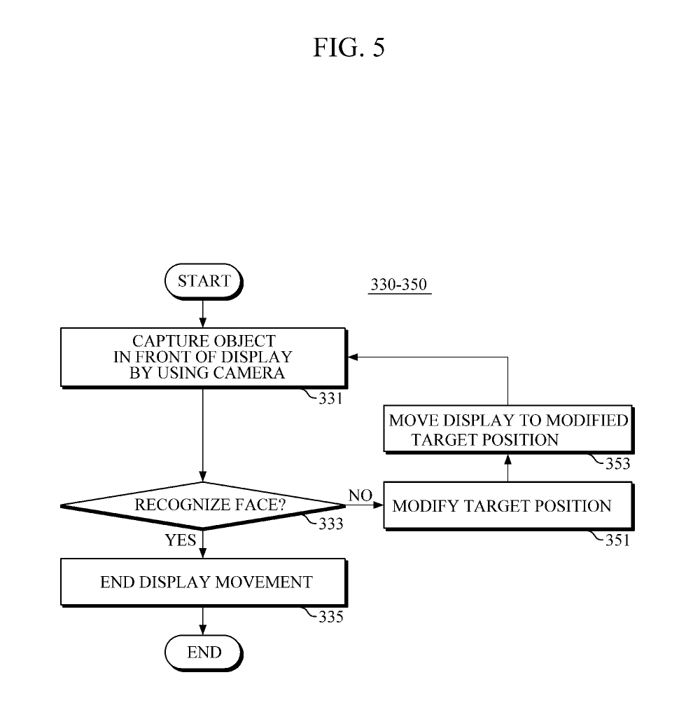

In addition, in 350, an operation for re-determining the modified target position, based on the face recognition result at the modified target position, and an operation for re-moving the display to the re-determined modified target position, may be repeated. Operations in 350 may be repeatedly performed until the face recognition result is positive. Operation 330 and operation 350 are specifically described below with reference to FIG. 5.

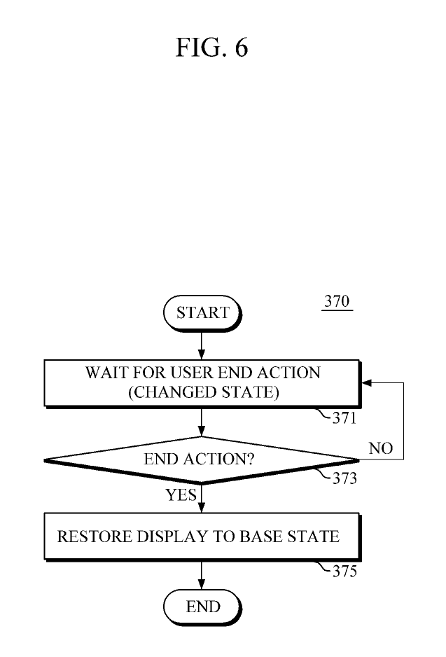

In controlling a position of a display to be restored in 370, the display returns to the original base state based on a user end action. Operation 370 is specifically described below with reference to FIG. 6.

FIG. 4 is a flowchart illustrating an example of an operation for controlling a position of a display based on an estimation according to FIG. 3.

Referring to FIG. 4, in 310, after a location of the face of a user is estimated, a display is moved from a current position in a base state to an initial target position.

In 310, first, in response to the display being in the base state, a user action detector waits for a user start action to be detected in 311. For example, if the user action, such as moving a wrist rapidly, inputting a voice command, or inputting a preset key button, or a combination thereof, is detected, whether the detected action is a preset user start action is determined in 313.

If the detected action has been determined as the start action, the display position estimator may, for example, detect the current user situation in 315, such as a situation where the user is currently driving, by detecting the movement of the display, and may estimate the face position of the user based on the detected situation in 317.

Then, a relative current position of the display is estimated with respect to the estimated face position of the user in 319, and an initial target position where the display will be moved may be determined based on the estimation result by a target position determiner in 321.

Then, a display position controller may output a control signal that enables the display of the smart watch to be moved from the relative current position to the initial target position. The output control signal may be transferred to, for example, a position movement mechanism, which relatively rotates the display with respect to a wrist band in 325. Thus, the display may be moved to the initial target position in 325.

FIG. 5 is a flowchart illustrating an example of an operation for determining a face position of the user, and an operation for controlling a position of a display based on face recognition in FIG. 3.

Referring to FIG. 5, for determining a face position of the user in 330, first, after the display reaches the initial target position or the modified target position, a front area where the display is facing is captured by the camera in 331. The camera may capture one or more images. Also, the image or images may be captured during a time interval (e.g., approximately for 0.1 second) set in advance.

The face of the user is recognized by using the captured image in 333.

If the face recognition result has been determined to be positive in 335, the movement of the display ends, and the display maintains at a current state where the display's position has been changed.

If the face recognition result has been determined to be negative, operations 351, 352, and 353 for controlling a position of display based on face recognition are progressed, and thereby a new target position may be generated by re-calculating in 351. Then, the display may be moved to a re-calculated target position, i.e., a modified target position in 353.

If the display reaches the new target position, the camera captures again to recognize the face again in 331, and the face is recognized again in 333. If the user's face is not recognized in the images, a modified target position is calculated again in 351, and the display is moved to a new modified target position in 353. These operations 331, 333, 351, and 353 may be repeated until the face recognition result is positive.

FIG. 6 is a flowchart illustrating an example of an operation for restoring a display to its original position according to FIG. 3.

Referring to FIG. 6, an operation 370 for controlling a position to be restored first starts with waiting for a user end action in a state where a display position is changed.

When the user action is detected, whether the detected action is a preset end action is determined in 373.

If the detected action has been determined as the end action, the display is removed to be restored from a current changed state to a base state in 375. Otherwise, the display is restored to an operation 371 of waiting for the user end action.

FIGS. 7 to 9 illustrate aspects of an example of a smart watch in which an apparatus and method for changing a display position of a smart watch is applied. In FIGS. 7 to 9, axes X, Y, and Z are indicating for three directions which are orthogonal to each other. In FIGS. 7 to 9 illustrated, the X axis is one of horizontal directions and indicates a longitudinal direction along a left arm H when the left arm H spreads out. The Y axis is the other one of horizontal direction and is orthogonal to the X axis. The Z axis indicates a direction that is orthogonal and perpendicular to both the X and Y axes.

FIG. 7 is a diagram illustrating an example of a display of a smart watch in a base state.

Referring to FIG. 7, a smart watch 10 is worn on a wrist of a user's left arm H. The main body 12 of smart watch 10 is attached to a wrist band 14, in which is referred to as a base state in this example. An upper side of the main body 12 includes a display including a camera 13 disposed thereon.

FIG. 8 is a diagram illustrating the example of the display of the smart watch of FIG. 7 in a state where the display is rotated with respect to the wrist band. This state is referred to as a target state in this example.

Referring to FIG. 8, the smart watch 10′ is worn on the wrist of the user's left hand H. The smart watch 10′ is identical to a smart watch 10 of FIG. 7, and only a position of a main body 12′ is changed from a base state to a target state. The smart watch 10′ is attached to a wrist band 14 in a state where a display position is changed as the display of the main body 12′ has rotated towards the user face so as to form an angle with the bottom surface of the main body. An upper side of the main body 12′ has a display 15′ including a camera 13′ disposed thereon. In another example, the camera 13′ may be disposed outside of the display screen area of the display 15′.

FIG. 9 is a “A-A” sectional view of the smart watch of FIG. 7 for comparing and showing relative positions of displays of FIGS. 7 and 8.

Referring to FIG. 9, a smart watch 10 that includes a display in a base state and a smart watch 10′ that includes a display in a changed state are both illustrated. In FIG. 9 illustrated, a main body 12 of the smart watch 10 has a left side 12a that is round-shaped. Also, a side 14a of the wrist band corresponding to a left side 12b is round-shaped. A right side 12d is fixed to be rotatable by a right side 14c and a hinge 22. The hinge 22 may be operated by, for example, a driving motor that is provided with power from a battery inside the smart watch. The driving motor may be equipped inside the wrist band 14 or main body 12. A lower side 12c of the main body 12 may be disposed on a side 14b of the wrist band corresponding thereto. An upper side 12a of the main body 12 corresponds to a surface of a display 15. A camera 13 is installed on a part of the display 15 that is configured to move relative to the lower side 12c of the main body 12 and the wrist band 14.

If the display position of the smart watch 10 is changed, the wrist band 14 is wound on the wrist as it is; however, the display 15 of the main body 12′ may turn by a degree θ around the hinge 22 as illustrated in a smart watch 10′. Thus, a left side 12a′, a lower side 12c, and a right side 12d of the main body 12′ may be set apart from corresponding sides 14a, 14b, and 14c of the wrist band. In this example, the degree θ to which the main body turns may be between 0 and 90 degrees.

The exemplary embodiments illustrated in FIGS. 1 to 9 are about a smart watch that includes a main body's specific area that is attached to a certain area of the wrist band in a manner that is rotatable. Further, a smart watch whose lower side of the main body is attached to the wrist band to translate along the wrist band may be implemented. For example, the lower side of the main body may be connected to the wrist band with a gear therebetween in a rail structure. As the gear rotates, the main body may be moved from one point to another point on the wrist band along the rail. Furthermore, if the display of the smart watch is a flexible display, the display states may be changed according to shapes of the flexible display.

A display may be implemented as a liquid crystal display (LCD), a light-emitting diode (LED) display, a plasma display panel (PDP), a screen, a terminal, and the like. A display screen may be a physical structure that includes one or more hardware components that provide the ability to render a user interface and/or receive user input. The screen can encompass any combination of display region, gesture capture region, a touch sensitive display, and/or a configurable area. The screen can be embedded in the hardware or may be an external peripheral device that may be attached and detached from the apparatus. The display may be a single-screen or a multi-screen display. A single physical screen can include multiple displays that are managed as separate logical displays permitting different content to be displayed on separate displays although part of the same physical screen.

A user interface may be responsible for inputting and outputting input information regarding a user and/or an image. The interface unit may include a network module for connection to a network and a universal serial bus (USB) host module for forming a data transfer channel with a mobile storage medium. In addition, the user interface may include an input/output device such as, for example, a mouse, a keyboard, a touch screen, a monitor, a speaker, a screen, and a software module for running the input/output device.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A smart watch comprising:
a display having a position that is changeable;
an estimation-based position controller configured to determine an initial target position based on a face position and control the display to be moved to the determined initial target position;
a face position determiner configured to, based on a face recognition result, determine whether a face exists in front of the display positioned at the initial target position; and
a face recognition-based position controller configured to, in response to determining a face does not exist in front of the display, determine a modified target position to enable the display to be positioned toward a face and control the display to be moved to the modified target position.

2. The smart watch of claim 1, wherein the estimation-based position controller comprises:
a user action detector configured to detect a start action that is set in advance;
a display position estimator configured to, in response to the detection of the start action, detect a current situation of a user, and based on the detected situation, estimate a face position and a current position of the display;
a target position determiner configured to, based on the estimation result of the display position estimator, determine the initial target position where the display is to be moved; and
a display position controller configured to output a control signal that enables the display to be moved from the current position to the initial target position.

3. The smart watch of claim 2, wherein the user action detector is configured to detect the start action through one or more of a gesture recognized by a motion sensor, a voice command recognized by a microphone, and a command input by a key button.

4. The smart watch of claim 2, wherein the display position estimator detects the current situation of the user based on estimation data stored in advance in response to at least one of a current state of the display recognized by a motion sensor, a voice command recognized by a microphone, and a command input by a key button.

5. The smart watch of claim 2, wherein:
the face position determiner comprises a face recognizer configured to, in response to the display reaching the initial target position or the modified target position, capture a front where the display is facing and recognize the face during a predetermined time interval; and
the face recognition-based position controller comprises:
a modified target position determiner configured to, in a case where the recognition result of the face recognizer has been determined to be negative, repeatedly perform an operation for re-calculating the initial target position and determining the modified target position, or an operation for re-calculating the modified target position and re-determining the modified target position; and
a display position controller configured to output a control signal that enables the display to be moved to the determined or re-determined modified target position every time the modified target position is determined or re-determined by the modified target position determiner.

6. The smart watch of claim 5, wherein the target position determiner is configured to determine or re-determine the modified target position based on a preset standard or a new estimation result of the display position estimator.

7. The smart watch of claim 1, further comprising:
a restoration position controller configured to restore the display to an original base state based on a user action.

8. The smart watch of claim 1, wherein:
the smart watch comprises a predetermined area of a main body that is attached to a predetermined area of a wrist band in a manner that is rotatable, and
the estimation-based position controller and the face recognition-based position controller operate a display position moving mechanism that enables the display to be rotated with regard to the wrist band along a predetermined area where the display is attached in a manner that is rotatable.

9. The smart watch of claim 1, wherein:
the smart watch is attached in a manner that enables a lower side of a main body to translate along a wrist band; and
the estimation-based position controller and the face recognition-based position controller operate a display position moving mechanism that enables the display to translate with respect to the wrist band in a direction of winding up a wrist.

10. The smart watch of claim 1, wherein:
the display is a flexible display; and
the estimation-based position controller and the face recognition-based position controller operate a display shape changing mechanism that changes the flexible display between a curved shape and a plane shape.

11. A method of controlling a smart watch comprising a display of which position is changeable, the method comprising:
controlling an estimation-based position to determine an initial target position based on a face location and to move the display to the determined initial target position;
determining a face position based on a face recognition result in order to determine whether a face exists in front of the display moved to the initial target position; and
controlling a face recognition-based position to, in response to determining a face does not exist in front of the display, determine a modified target position to enable the display to be positioned toward the face and control the display to be moved to the modified target position.

12. The method of claim 11, wherein the controlling of the estimation-based position comprises:
detecting a user action to detect a start action that is set in advance;
estimating a display position to, in response to the detection of the start action, detect a current situation of a user, and based on the detected situation, estimate a face position and a current position of the display;
determining an initial target position to, based on the estimation result from the estimating of the display position, determine the initial target position where the display is to be moved; and
controlling a display initial position to output a control signal that enables the display to be moved from the current position to the initial target position.

13. The method of claim 12, wherein the detecting of the user action comprises detecting the start action through one or more of a gesture recognized by a motion sensor, a voice command recognized by a microphone, and a command input by a key button.

14. The method of claim 12, wherein the estimating of the display position comprises detecting the current situation of the user based on estimation data stored in advance in response to at least one of a current state of the display recognized by a motion sensor, a voice command recognized by a microphone, and a command input by a key button.

15. The method of claim 12, wherein:
the determining of the face position comprises recognizing a face in an image capturing a front of the display during a predetermined time interval in response to the display reaching the initial target position or the modified target position; and
the controlling of the face recognition-based position comprises:
determining a modified target position to, in response to the recognition result from the recognizing of the face of the user being determined to be negative, repeatedly performs an operation for re-calculating the initial target position and determining the modified target position, or an operation for re-calculating the modified target position and re-determining the modified target position; and
controlling a display modification position to output a control signal that enables the display to be moved to the determined or re-determined modified target position every time the modified target position is determined or re-determined in the determining of the modified target position.

16. The smart watch of claim 15, wherein the determining of the modified target position comprises determining the modified target position based on a preset standard or a new estimation result from the estimating of the display position.

17. The method of claim 11, further comprising:
controlling a restoration position to restore the display to an original base state based on a user action.

18. The method of claim 11, wherein:
the smart watch comprises a predetermined area of a main body that is attached to a predetermined area of a wrist band in a manner that is rotatable, and
the controlling of the estimation-based position and the controlling of the face recognition-based position comprise operating a display position moving mechanism that enables the display to be rotated with regard to the wrist band along a predetermined area where the display is attached in a manner that is rotatable.

19. The method of claim 11, wherein:
the smart watch is attached in a manner that enables a lower side of a main body to translate along a wrist band; and
the controlling of the estimation-based position and the controlling of the face recognition-based position comprise operating a display position moving mechanism that enables the display to translate with respect to the wrist band in a direction of winding up a wrist

20. The method of claim 11, wherein:
the display is a flexible display; and
the controlling of the estimation-based position and the controlling of the face recognition-based position comprise operating a display shape changing mechanism that changes the flexible display between a curved shape and a plane shape.

21. A smart watch comprising:
a main body configured to be positioned on a wrist;
a display configured to be positioned in the main body and having a display surface configured to form a tilt angle with respect to a bottom surface of the main body;
a camera configured to capture an image;
a face recognizer configured to recognize a face from the image; and
a position controller configured to adjust the tilt angle of the display surface based on a location of a face recognized in the image captured by the camera.

22. The smart watch of claim 21, wherein the position controller is configured to change the tilt angle of the display surface in response to the face recognizer determining that a face is not recognized in the image captured by the camera.

23. The smart watch of claim 21, wherein the display surface is configured to form a tilt angle of approximately 20 to 90 degrees with the bottom surface of the main body.
